(19) United States
(12) Patent Application Publication
(10) Pub. No.: US 2026/0196755 A1
(43) Pub. Date: Jul. 9, 2026

(54) FLEXIBLE FLAT CABLE CONNECTOR

(71) Applicant: HAMBURG (JIANGSU) CO., LTD., Huaian (CN)

(72) Inventor: Ya-Li HUANG, New Taipei City (TW)

(73) Assignee: HAMBURG (JIANGSU) CO., LTD., Huaian (CN)

(21) Appl. No.: 19/014,512

(22) Filed: Jan. 9, 2025

(51) Int. Cl. H01R 12/77; H01R 12/79

(52) U.S. Cl. CPC H01R 12/774; H01R 12/79

(57) ABSTRACT

A flexible flat cable connector is provided and configured to be mounted on a circuit board. The flexible flat cable connector has a base part, a plurality of pins, a cover part, and at least one elastic unit. The cover part is tiltably mounted on the base part and selectively covers an end of each one of the pins. The at least one elastic unit is mounted on the base part and connected to the cover part. When the cover part is inclined with respect to the base part, the cover part tends to tilt to be parallel to the base part because of the at least one elastic unit. When the cover part is parallel to the base part, a flexible flat cable is clamped by the cover part and the base part.

### BACKGROUND OF THE INVENTION

### 1. Field of the Invention

The present invention relates to a connector, especially to an FFC connector that can securely and firmly connect a flexible flat cable (i.e. FFC) and a circuit board.

### 2. Description of the Prior Arts

Flexible Flat Cable, also known as FFC, is a type of electrical cable. As its name suggests, FFC is flat and flexible and therefore is formed in the shape of a stripe. Correspondingly, a connector for FFC, i.e. FFC connector, is formed in an elongated shape.

The elongated FFC connector is mounted on a circuit board and includes two parts. A first part is mounted on the circuit board, and a second part is pivotally mounted on the first part. When the second part is tilted parallel to the first part, a gap is formed between the first part and the second part, and the FFC can be disposed in the gap and fixed by the first part and the second part.

Two bumps are formed on the first part and two cavities are formed on the second part. If the second part is tilted parallel to the first part, the two bumps engage with the two cavities, so that the second part is fixed and cannot be tilted any more. Therefore, the FFC is clamped by the first part and the second part.

However, the engaging portion (i.e. the bumps and the cavities) may be worn after use over time, so the clamping may become weak and loose, and thus the FFC will depart from the FFC connector. Especially, if a device with a conventional FFC connector works at an environment frequently under shaking or vibrations, the engaging portion will get heavier wear. Even though the device with the conventional FFC connector works at a static environment, if the device receives an impulse, the bumps still may separate from the cavities. Therefore, the FFC may be highly likely to break away from the conventional FFC connector.

To overcome the shortcomings, the present invention provides an FFC connector to mitigate or obviate the aforementioned problems.

### SUMMARY OF THE INVENTION

The main objective of the present invention is to provide an FFC connector that can steadily connect a flexible flat cable and a circuit board even when situated in a shaking or vibrating environment or when undergoing an impulse.

The flexible flat cable connector comprises a base part, a plurality of pins, a cover part, and at least one elastic unit. The pins are mounted through the base part. Each one of the pins comprises a first end and a second end opposite each other. The cover part is tiltably mounted on the base part and selectively covers the first end of each one of the pins. The at least one elastic unit is mounted on the base part and connected to the cover part.

The cover part can be tilted to a first position and a second position. When the cover part is in the first position, the cover part is inclined with respect to the base part and tends to tilt to the second position because of the at least one elastic unit. When the cover part is in the second position, the cover part is parallel to the base part and a gap is formed between the base part and the cover part. The first end of each one of the pins is covered by the cover part.

The present flexible flat cable connector is configured to connect the circuit board and a flexible flat cable. The cover part is tilted to the first position first so that the gap between the cover part and the base part is open. Then, the flexible flat cable is put in the opened gap and connected to the first ends of the pins. After the cover part is released, the elastic units press the cover part back to the second position, and thus the cover part and the base part clamp the flexible flat cable. With the elastic units keeping pressing the over part, even though the present flexible flat cable connector works in a shaking or vibrating environment or undergoes an impulse, the cover part will still firmly close and clamp the flexible flat cable. Besides, because the elastic units constantly press the cover part, even the flexible flat cable is not clamped by the present flexible flat cable connector, the cover part is still firmly closed at the second position even in a shaking or vibrating environment or undergoes an impulse.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an FFC connector in accordance with a first embodiment of the present invention;

FIG. 2 is an enlarged perspective view of the FFC connector in FIG. 1, showing the FFC connector in the second position;

FIG. 3 is a sectional view of the FFC connector in FIG. 2;

FIG. 4 is an enlarged perspective view of the FFC connector in FIG. 1, showing the FFC connector in the second position;

FIG. 5 is a sectional view of the FFC connector in FIG. 4;

FIG. 6 is an exploded perspective view of the FFC connector in FIG. 1;

FIG. 7 is another exploded perspective view of the FFC connector in FIG. 1;

FIG. 8 is a perspective view of an FFC connector in accordance with a second embodiment of the present invention;

FIG. 9 is an enlarged perspective view of the FFC connector in FIG. 8, showing the FFC connector in the second position;

FIG. 10 is a sectional view of the FFC connector in FIG. 8;

FIG. 11 is an enlarged perspective view of the FFC connector in FIG. 7, showing the FFC connector in the second position;

FIG. 12 is a sectional view of the FFC connector in FIG. 11;

FIG. 13 is an exploded perspective view of the FFC connector in FIG. 8;

FIG. 14 is a perspective view of an elastic unit of the FFC connector in FIG. 8.

### DETAILED DESCRIPTION OF THE PREFERRED EMBODIMENTS

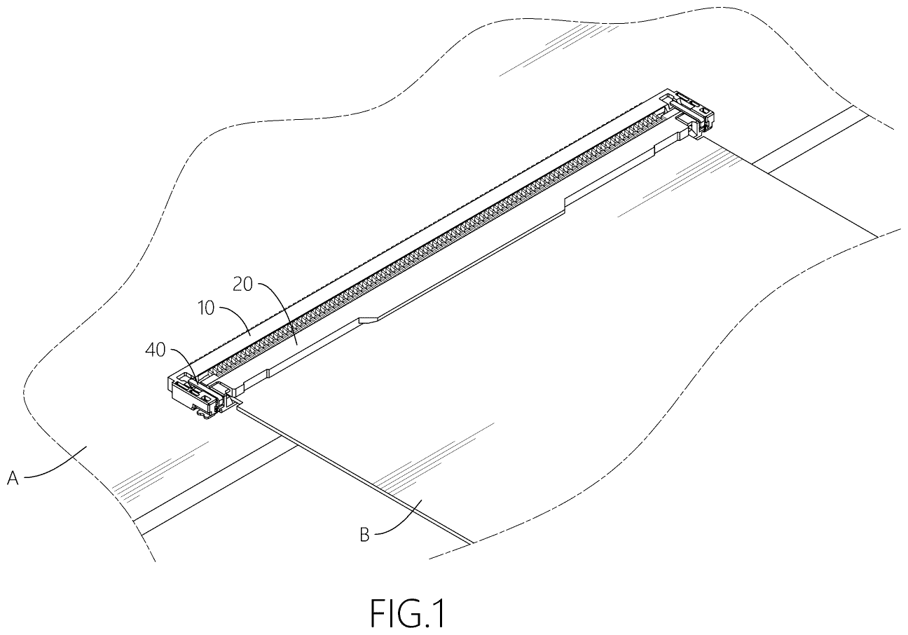

Please refer to FIGS. 1 to 3. A flexible flat cable connector (i.e. FFC connector) according to the first embodiment of the present invention is provided. The flexible flat cable connector is configured to be mounted on a circuit board A and clamp a flexible flat cable B so that the flexible flat cable B is electrically connected to the circuit board A.

The flexible flat cable connector comprises a base part 10, a cover part 20, a plurality of pins 30, and at least one elastic unit 40.

The base part 10 is mounted on the circuit board A. The base part 10 may be an elongated board or plate and has a groove 11 extending parallel to a lengthwise side of the elongated board.

The cover part 20 is tiltably mounted on the base part 10. In this embodiment, the cover part 20 is mounted in the groove 11 of the base part 10. Therefore, the cover part 20 may be another elongated board received in and corresponding to the groove 11 of the base part 10 in shape.

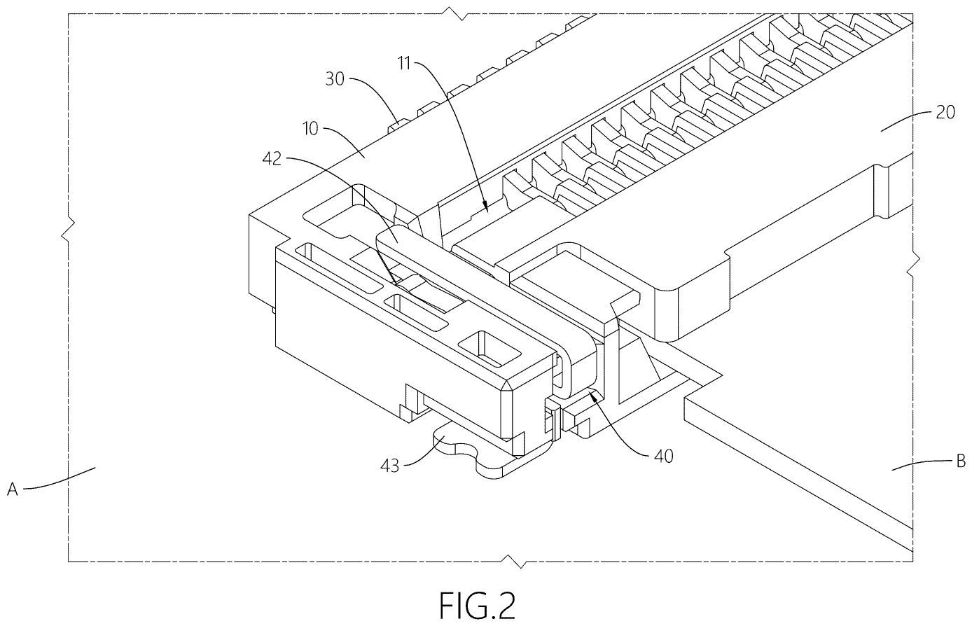

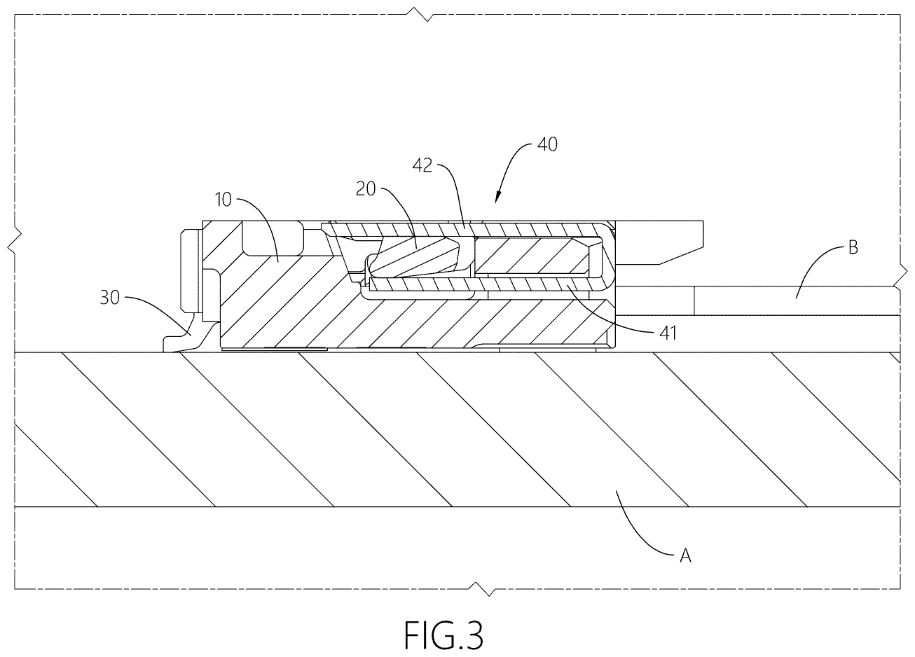

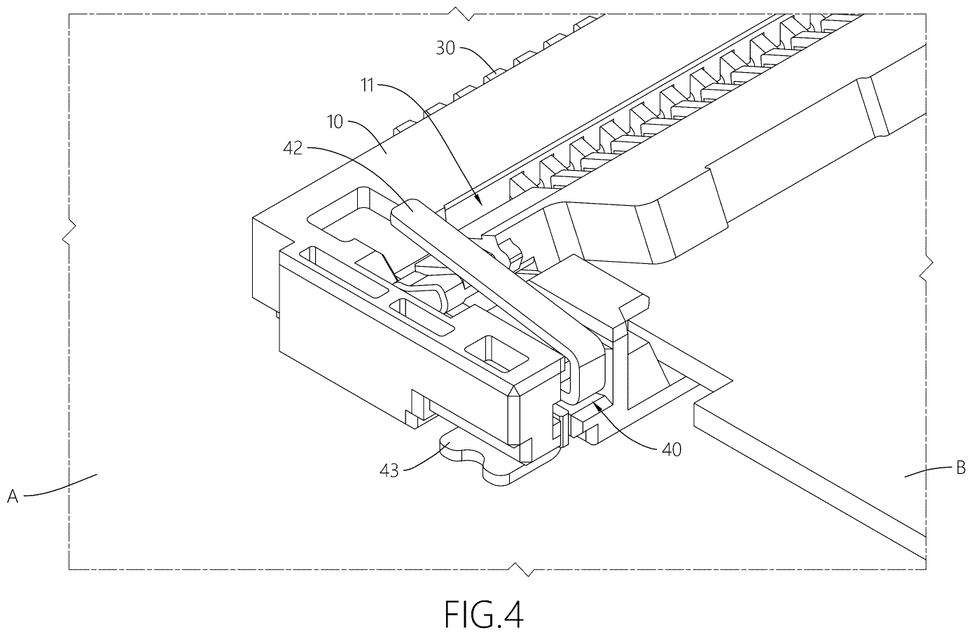

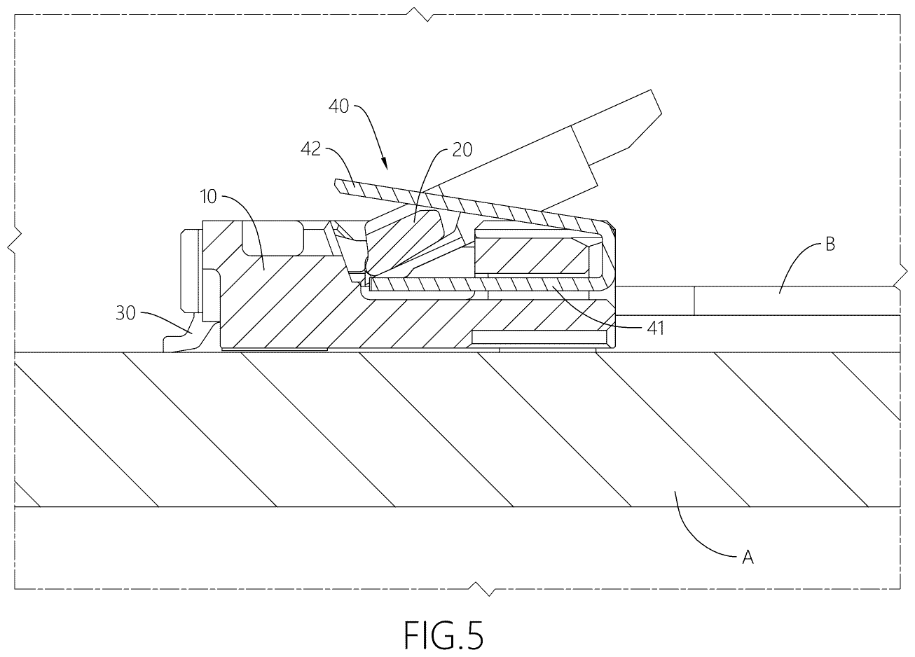

Please also refer to FIGS. 4 and 5. The cover part 20 can be tilted to a first position and a second position. When the cover part 20 is in the first position (as shown in FIGS. 4 and 5), the cover part 20 is inclined with respect to the base part 10. When the cover part 20 is in the second position (as shown in FIGS. 2 and 3), the cover part 20 is parallel to the base part 10. In other words, when the cover part 20 is in the second position, a top surface of the base part 10 is aligned with a top surface of the cover part 20. Further, when the cover part 20 is in the second position, a gap is formed between the base part 10 and the cover part 20.

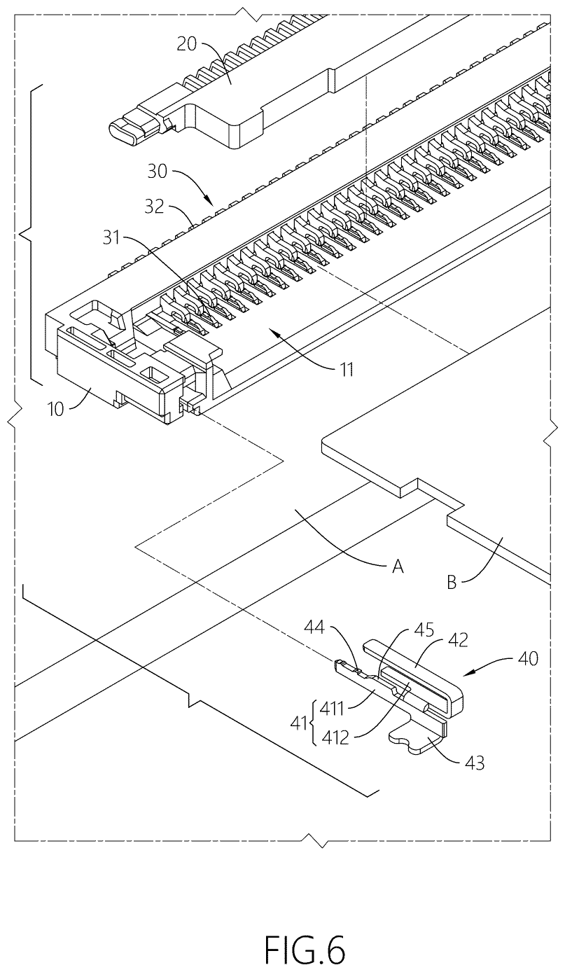

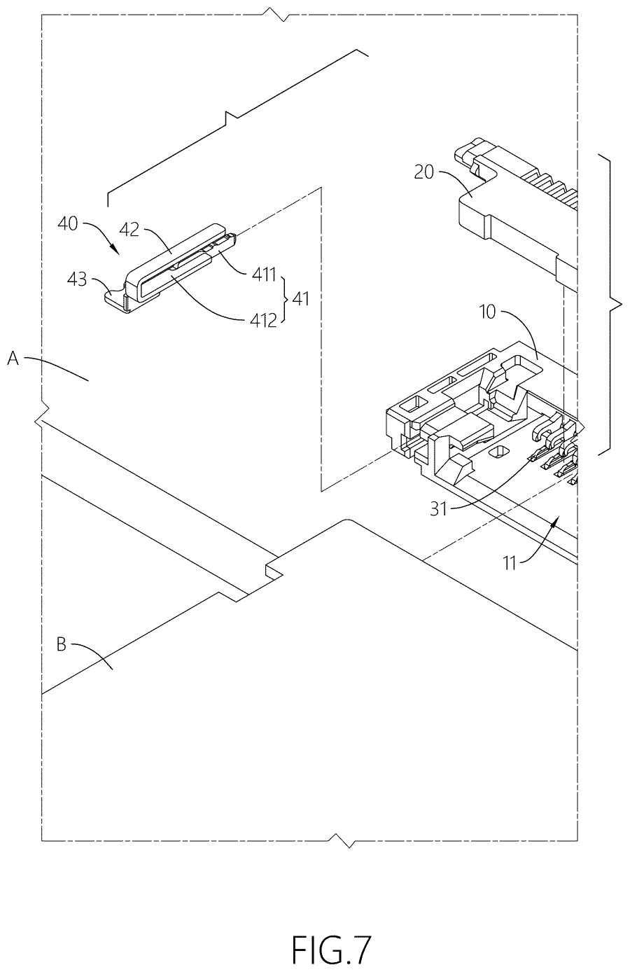

Please refer to FIGS. 2, 6, and 7. The pins 30 are mounted through the base part 10. Each one of the pins 30 comprises a first end 31 and a second end 32 opposite each other. In this embodiment, the first end 31 of each pin 30 is located in the groove 11 of the base part 10 and selectively covered by the cover part 20. The second end 32 of each pin 30 is located at an opposite side of the base part 10 and configured to electrically connect to the circuit board A.

The at least one elastic unit 40 is mounted on the base part 10 and connected to the cover part 20. The at least one elastic unit 40 makes the cover part 20 tend to keep in the second position. In this embodiment, the number of the at least one elastic unit 40 is two. The two elastic units 40 are respectively connected to two opposite ends of the cover part 20. Precisely, the two elastic units 40 are located on two ends of the base part 10 and connected to the two ends of the cover part 20. The pins 30 are located between the two elastic units 40.

Each one of the elastic units 40 comprises a fixing portion 41, an active portion 42, and selectively has a ground portion 43, a first protrusion 44, and a second protrusion 45. Each elastic unit 40 is formed integrally. Precisely, the elastic unit 40 is manufactured via bending an elastic metal sheet.

In the first embodiment, each one of the elastic units 40 comprises a fixing portion 41, an active portion 42, a ground portion 43, a first protrusion 44, and a second protrusion 45. The fixing portion 41 is fixed on the base part 10. Precisely, the fixing portion 41 comprises a first piece 411 and a second piece 412. The first piece 411 and the second piece 412 are perpendicular to each other. A width direction of the first piece 411 is perpendicular to the top surface of the base part 10 and a width direction of the second piece 412 is parallel to the top surface of the base part 10.

The first protrusion 44 is formed on an edge of the first piece 411 of the fixing portion 41, such that the fixing portion 41 securely engages with the base part 10 via the first protrusion 44. The second protrusion 45 is formed on an edge of the first piece 411 of the fixing portion 41. Precisely, the first protrusion 44 and the second protrusion 45 may be formed at the same edge of the first piece 411. The second protrusion 45 abuts the cover part 20. In other words, the second protrusion 45 pushes the cover part 20 away from the base part 10.

The fixing portion 41 connects the active portion 42 and the ground portion 43. In other words, the fixing portion 41 is located between the active portion 42 and the ground portion 43.

The active portion 42 is connected to the base part 10 via the fixing portion 41 and presses the cover part 20 toward the base part 10, such that the cover part 20 tends to be parallel to the base part 10. In other words, the active portion 42 makes the cover part 20 tend to keep in the second position.

In this embodiment, the base portion is located between the ground portion 43 and the active portion 42. Precisely, the ground portion 43 is located between the base portion and the circuit board A, and the ground portion 43 is electrically connected to the circuit board A, such that the ground portion 43 provides an additional grounding function to the cover part 20 and the flexible flat cable B.

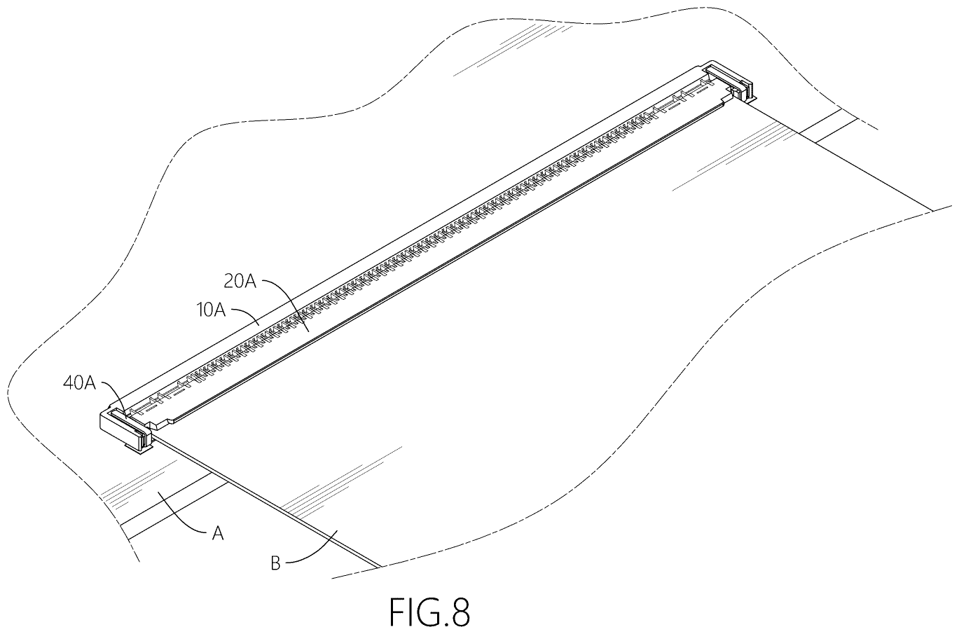

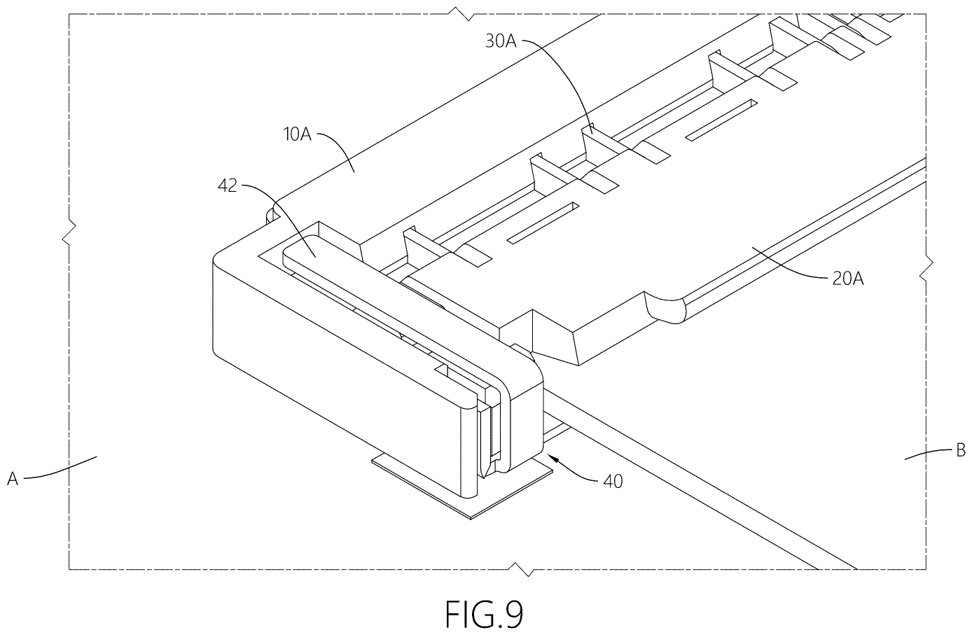

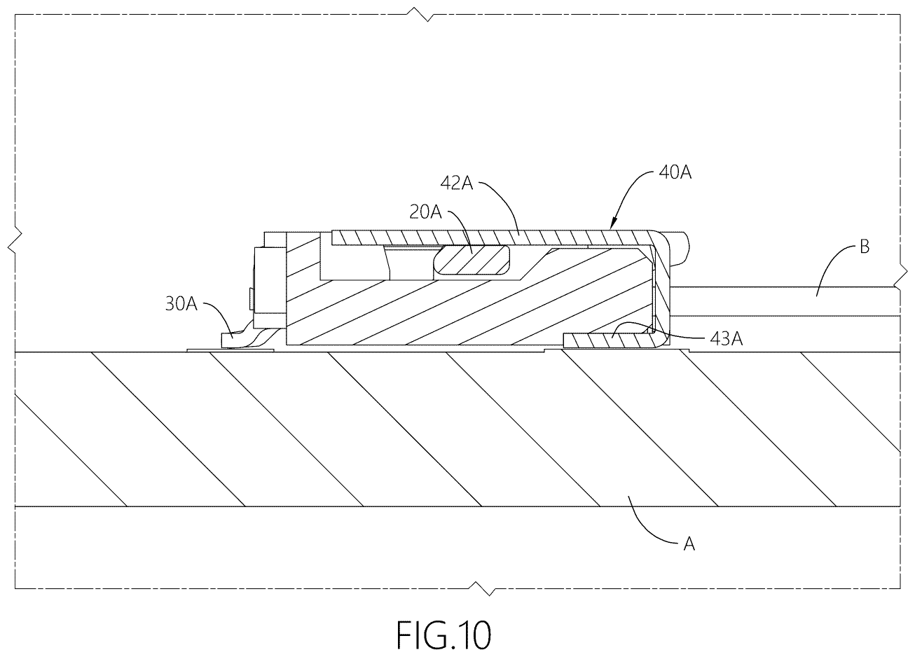

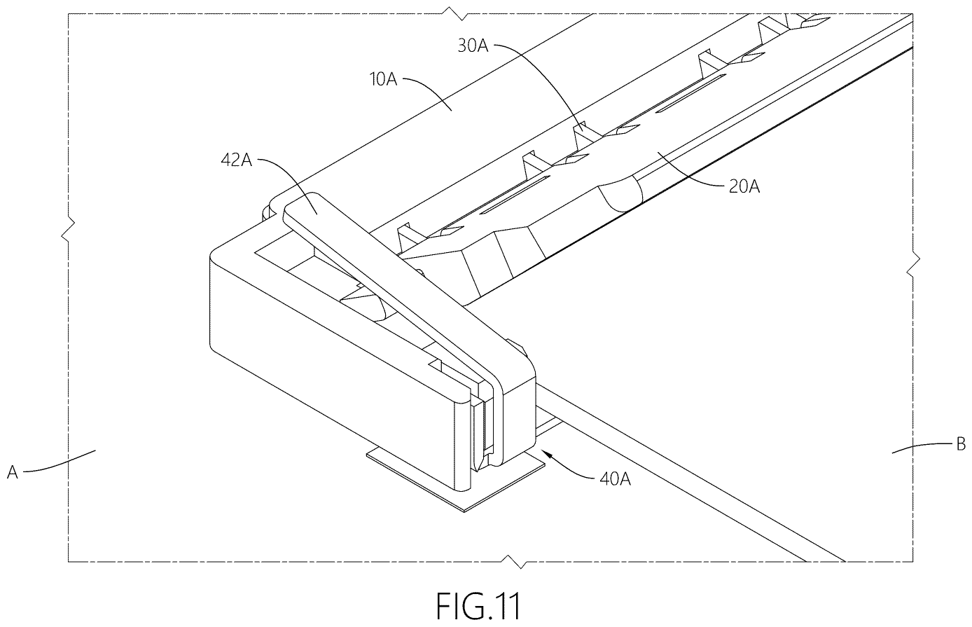

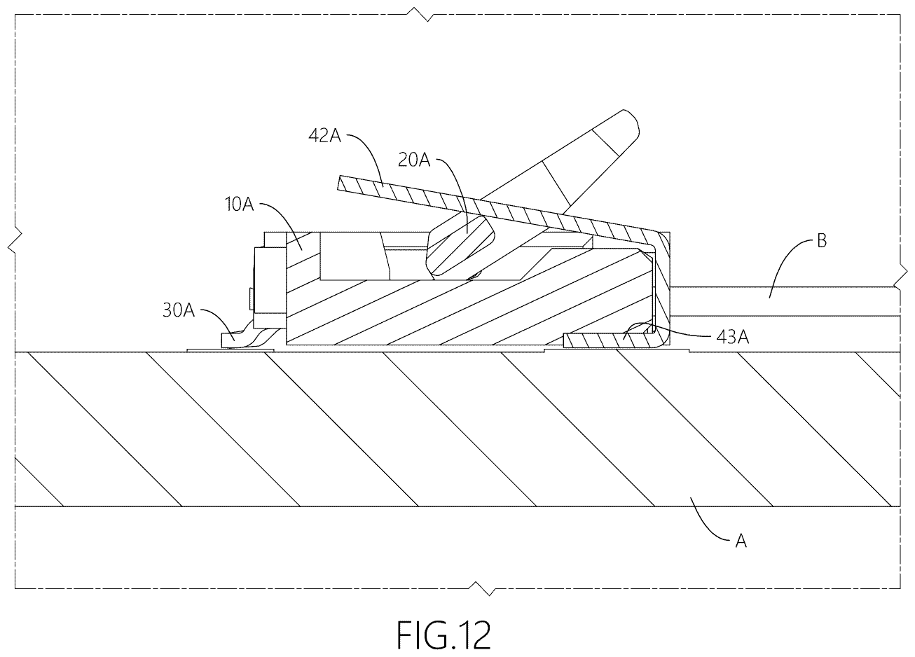

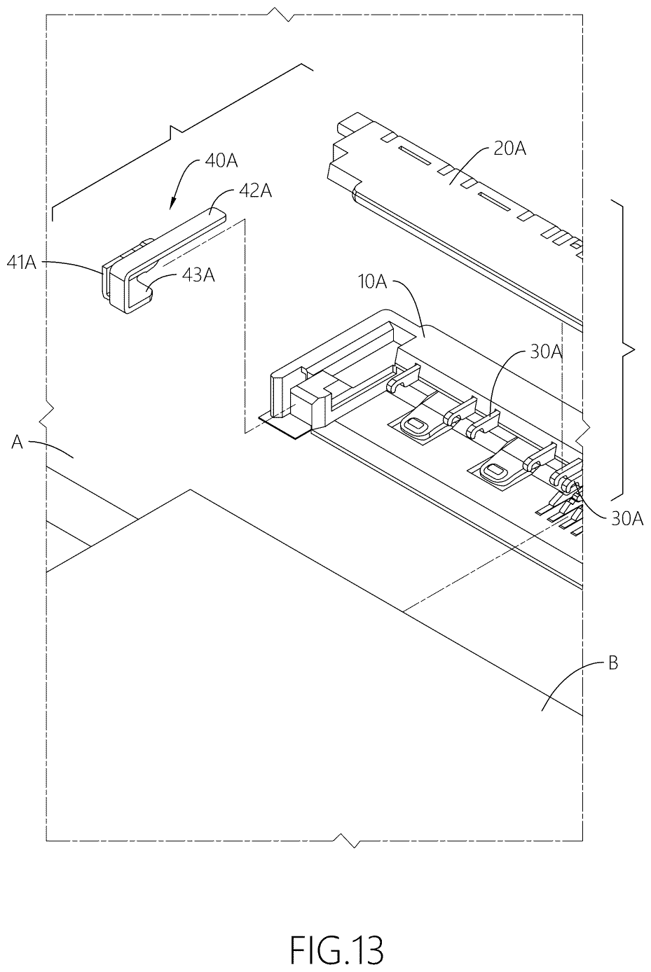

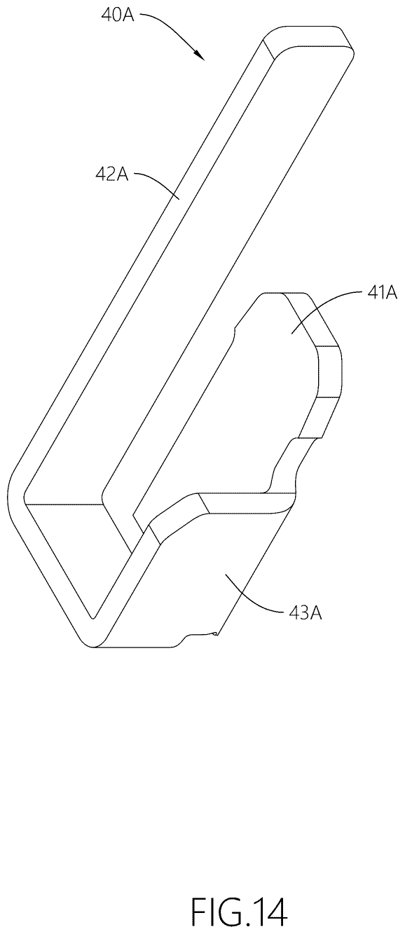

Then please refer to FIGS. 8 to 14. In the second embodiment, the technical features are almost the same as those of the first embodiment, but the only difference is that the fixing portion 41A and the active portion 42A are connected by the ground portion 43. In other words, the ground portion 43A connects the fixing portion 41A and the active portion 42A and is located between the fixing portion 41A and the active portion 42A.

Therefore, like the first embodiment, the second embodiment of the present invention has a cover part 20A, a base part 10A, multiple pins 30A, and two elastic units 40A, and each elastic unit 40aA has the aforesaid fixing portion 41A, active portion 42A, and ground portion 43A. The cover part 20A also can be tilted to the first position which is inclined with respect to the base part 10A and the second position which is parallel to the base part 10A.

With the aforementioned structures, the present flexible flat cable connector is mounted on a circuit board A. To connect the circuit board A and a flexible flat cable B, the cover part 20/20A is tilted to the first position first so that the gap between the cover part 20/20A and the base part 10/10A is open. Then, the flexible flat cable B is put in the opened gap and connected to the first ends of the pins 30/30A. After the cover part 20/20A is released, the elastic units 40/40A press the cover part 20/20A back to the second position, and thus the cover part 20/20A and the base part 10/10A clamp the flexible flat cable B. With the elastic units 40/40A keeping pressing the cover part 20/20A, even though the present flexible flat cable connector works in a shaking or vibrating environment or undergoes an impulse, the cover part 20/20A will still firmly close and clamp the flexible flat cable B. Besides, because the elastic units 40/40A constantly press the cover part 20/20A, even the flexible flat cable B is not clamped by the present flexible flat cable connector, the cover part 20/20A is still firmly closed at the second position even in a shaking or vibrating environment or undergoes an impulse.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A flexible flat cable connector configured to be mounted on a circuit board and clamp a flexible flat cable, the flexible flat cable connector comprising:
a base part;
a plurality of pins mounted through the base part; each one of the pins comprising:
a first end and a second end opposite each other;
a cover part tiltably mounted on the base part and selectively covering the first end of each one of the pins;
at least one elastic unit mounted on the base part and connected to the cover part;
wherein the cover part is tiltable to a first position and a second position; when the cover part is in the first position, the cover part is inclined with respect to the base part and tends to tilt to the second position because of the at least one elastic unit; when the cover part is in the second position, the cover part is parallel to the base part and a gap is formed between the base part and the cover part; the first end of each one of the pins is covered by the cover part.

2. The flexible flat cable connector as claimed in claim 1, wherein the at least one elastic unit includes two said elastic units, and the two elastic units respectively connect two opposite ends of the cover part.

3. The flexible flat cable connector as claimed in claim 2, wherein the pins are located between the two elastic units.

4. The flexible flat cable connector as claimed in claim 1, wherein each one of the at least one elastic unit comprises:
a fixing portion fixed on the base part;
an active portion connected to the base part and configured to press the cover part toward the base part, such that the cover part tends to be parallel to the base part.

5. The flexible flat cable connector as claimed in claim 3, wherein each one of the two elastic units comprises:
a fixing portion fixed on the base part;
an active portion connected to the base part and configured to press the cover part toward the base part, such that the cover part tends to be parallel to the base part.

6. The flexible flat cable connector as claimed in claim 4, wherein each one of the at least one elastic unit is formed integrally.

7. The flexible flat cable connector as claimed in claim 5, wherein each one of the two elastic units is formed integrally.

8. The flexible flat cable connector as claimed in claim 4, wherein each one of the at least one elastic unit comprises at least one first protrusion on the fixing portion, such that the fixing portion securely engages with the base part.

9. The flexible flat cable connector as claimed in claim 7, wherein each one of the two elastic units comprises at least one first protrusion on the fixing portion, such that the fixing portion securely engages with the base part.

10. The flexible flat cable connector as claimed in claim 4, wherein each one of the at least one elastic unit comprises a ground portion connected to the fixing portion, the base portion located between the ground portion and the active portion.

11. The flexible flat cable connector as claimed in claim 9, wherein each one of the two elastic units comprises a ground portion connected to the fixing portion, the base portion located between the ground portion and the active portion.

12. The flexible flat cable connector as claimed in claim 10, wherein the ground portion and the active portion are connected by the fixing portion.

13. The flexible flat cable connector as claimed in claim 11, wherein the ground portion and the active portion are connected by the fixing portion.

14. The flexible flat cable connector as claimed in claim 10, wherein the fixing portion comprises:
a first piece, a width direction of the first piece being perpendicular to a top surface of the base part; and
a second piece, a width direction of the second piece being parallel t o the top surface of the base part.

15. The flexible flat cable connector as claimed in claim 13, wherein the fixing portion comprises:
a first piece, a width direction of the first piece being perpendicular to a top surface of the base part; and
a second piece, a width direction of the second piece being parallel t o the top surface of the base part.

16. The flexible flat cable connector as claimed in claim 4, wherein each one of the at least one elastic unit comprises at least one second protrusion on the fixing portion, and the at least one second protrusion abuts the cover part.

17. The flexible flat cable connector as claimed in claim 15, wherein each one of the two elastic units comprises at least one second protrusion on the first piece of the fixing portion, and the at least one second protrusion abuts the cover part.

18. The flexible flat cable connector as claimed in claim 10, wherein the fixing portion and the active portion are connected by the ground portion.

19. The flexible flat cable connector as claimed in claim 11, wherein the fixing portion and the active portion are connected by the ground portion.
